(19) United States
(12) Patent Application Publication
(10) Pub. No.: US 2011/0202453 A1
(43) Pub. Date: Aug. 18, 2011

(54) SYSTEM AND METHOD FOR MOBILE SECURE TRANSACTION CONFIDENCE SCORE

(75) Inventors: Alfredo C. Issa, Apex, NC (US); Richard J. Walsh, Raleigh, NC (US)

(73) Assignee: OTO TECHNOLOGIES, LLC, Raleigh, NC (US)

(21) Appl. No.: 12/705,676

(22) Filed: Feb. 15, 2010

(51) Int. Cl. G06Q 40/00

(52) U.S. Cl. 705/39

(57) ABSTRACT

A computerized system and method for determining a mobile secure transaction confidence (MSTC) score and reporting the MSTC score to a financial transactor, such as a merchant or payment processor, is disclosed. The system includes a mobile device, such as a smart phone having a touch screen display, and sensors, such as an accelerometer. The method includes steps of collecting operational data for a mobile device, recording the operational data to establish short term and long term patterns pertaining to mobile device interaction characteristics, user traits, mobile device use characteristics or combinations thereof. Other steps include determining the MSTC score by comparison of the short term and long term patterns for the device interaction characteristics, user traits, and device use characteristics, then reporting the secure transaction confidence score to a financial transactor.

### FIELD OF THE DISCLOSURE

The present disclosure relates to providing secure point of sale (POS) transactions by way of mobile devices. In particular, the present disclosure provides mobile device users with a way to securely perform POS transactions with high confidence.

### BACKGROUND

It is commonplace to employ bank cards such as debit cards and credit cards and the like to facilitate financial transactions. The bank cards carry account information and related data that allow the bank card holder the ability to conduct financial transactions. There is a movement towards assigning financial information that is normally associated with bank cards to mobile devices, such as smart phones. In such an embodiment, the smart phone effectively acts like the bank card. As a result, instead of requiring a user to have a bank card to facilitate a financial transaction, the user can use his mobile device to transfer the account information and related data to a service provider or transactor to facilitate a financial transaction. Such financial transactions are referred to as mobile financial transactions. The financial information carried by the mobile device may be, but is not limited to, a system number, a bank number, an account number, a check number, a check digit, a country code, a name, an expiration date and discretionary data.

During a mobile financial transaction attempt, the financial information carried by the mobile device is wirelessly transferred from the mobile device to a service provider or transactor via a point of sale (POS) terminal, etc. Owners of mobile devices such as smart phones carrying financial information can typically perform the same financial transactions that are available to traditional bank card users. However, a problem exists in that a stolen smart phone having financial information can be used to criminally access bank accounts and make fraudulent financial transactions. As such, there is a need for a system and method that is useable to prevent fraudulent financial transactions via a stolen mobile device that is carrying financial information.

### SUMMARY

The present disclosure addresses the need to prevent fraudulent transactions via a stolen mobile device, such as a stolen smart phone carrying the financial information of a bank card. In general, a mobile secure transaction confidence (MSTC) score is generated and reported to a financial transactor to help prevent stolen mobile devices from being used to conduct fraudulent mobile financial transactions. For example, if an MSTC score for a mobile financial transaction is within a predetermined range, the mobile financial transaction is allowed to complete. If an MSTC score for the mobile financial transaction is outside of the predetermined range, the transaction is prevented from completing.

MSTC scores can be determined based on mobile device interaction characteristics, user traits, mobile device use characteristics, or any combination thereof. A mobile device interaction characteristic is an attribute that indicates how a mobile device is operated by a user of the mobile device. A user trait is an attribute of the mobile device user that is detectable by the mobile device. A device use characteristic is an attribute that indicates how content is acquired and consumed by the user.

Other type of characteristics such as location information associated with the mobile device or user may be used to supplement the determination of MSTC scores. For example, a mobile device interaction characteristic and the location of the user may need to both fall within defined criteria before a MSTC score that is acceptable to a transactor can be determined. Moreover, a voice characteristic and/or image characteristic from a photograph of the user may also further supplement the determination of MSTC scores.

In particular, an MSTC score is determined based upon operational data collected from a user's mobile device and is determined by comparing the mobile device's short term usage patterns to the mobile device's long term usage patterns. The MSTC score is sent to a financial transactor, such as a merchant or payment processor that ultimately decides whether or not to allow a requested mobile financial transaction to complete.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 is a block diagram representing one embodiment of the present system.

FIG. 2 is a diagram illustrating sampling of swipe styles and touch gestures via a touch screen interface of a user's mobile device.

FIG. 3 depicts the transaction confidence service (TCS) monitoring media consumption and website visits via operation of a user's mobile device.

FIG. 4 depicts TCS sampling of text messaging styles and abbreviations typically used by a mobile device user.

FIG. 5 is an exemplary graph showing a short term pattern and a long term pattern for known locations for a mobile device versus a time of day.

FIG. 6 is a diagram illustrating the sampling of media access (MAC) addresses of networkable equipment that share a wireless local area network (WLAN) with a user's mobile device.

FIG. 7 depicts sampling of biometric data in the form of a voice sample.

FIGS. 8A-8C depict a typical flow for a purchase using the system of the present disclosure.

FIG. 9 depicts a security process flow that incorporates data encryption and a digital rights management scheme.

FIG. 10 is a block diagram of a wireless smart phone that can be used as a mobile device in accordance with the present disclosure.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

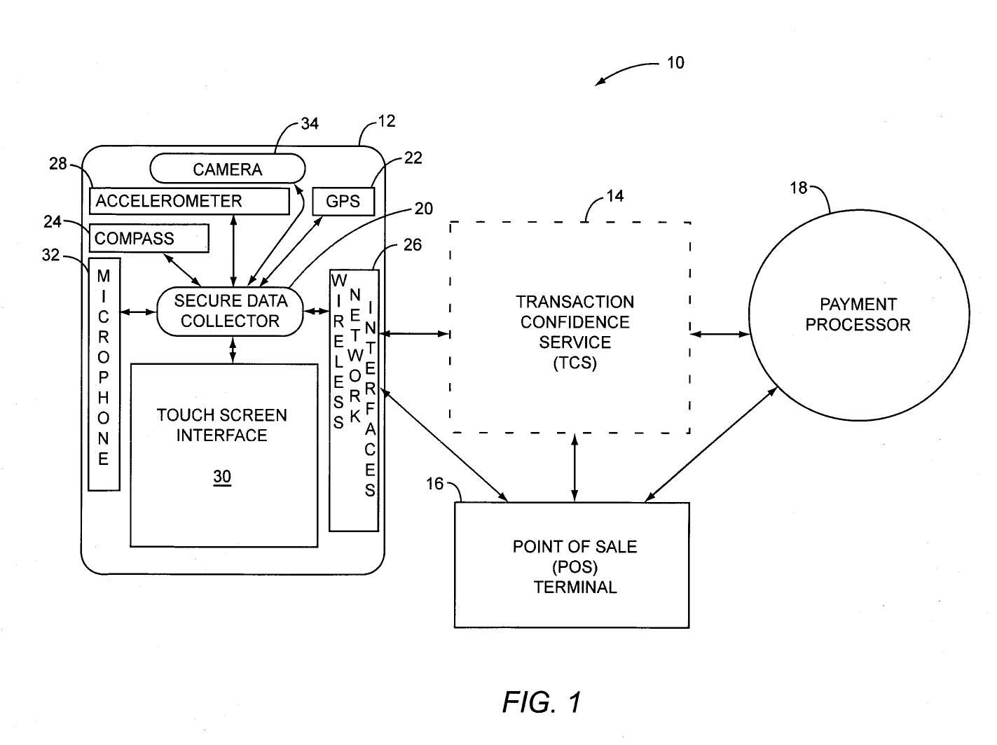

FIG. 1 depicts a system 10 according to the present disclosure. The system 10 includes a mobile device 12, a transaction confidence service (TCS) 14, a point of sale (POS) terminal 16, and a payment processor 18. The mobile device 12 includes a secure data collector 20 that may be a software or hardware function or combination thereof that is useable to collect operational data from operational data generating subsystems, which can be, but are not limited to, a location based service (LBS) such as a global position system (GPS) receiver 22, a compass 24, wireless network interfaces 26, an accelerometer 28, a touch screen interface 30, a microphone 32, and a camera 34. At least one of the wireless network interfaces 26 may be adapted to conduct near field communication with the POS terminal 16. At least another one of the wireless network interfaces 26 may be adapted to provide remote communication with the TCS 14. However, it is important to note that the TCS 14 may be provided as a software application that is executable on the mobile device 12. Moreover, the secure data collector 20 may be implemented as part of the TCS 14 when the TCS 14 is provided as a software application that is executable on the mobile device 12.

The secure data collector 20 securely collects operational data from the mobile device 12 for various factors such as mobile device interaction characteristics, user traits, and mobile device use characteristics. The TCS 14 stores the collected operational data for later analysis and immediate comparison to determine a mobile secure transaction confidence (MSTC) score. The operational data for each factor type may be mathematically operated on by known statistical methods to produce factor values for comparison. An MSTC score may be calculated by the TCS 14 after a long term pattern and a short term pattern for each factor making up the operational data is established. An MSTC score reflects anomalies between the short term and long term patterns as negative contributors. Anomalies can be detected by comparing a recently collected discrete or continuous factor value with long term pattern values of the same factor type. For example, a factor, such as a user trait short term pattern, may be compared with user trait long term pattern.

Determination of an MSTC score may take place upon request or on a schedule. In a preferred embodiment of the present disclosure, an MSTC score is calculated by summing the differences between the long term patterns and short term patterns for each factor of operational data collected and recorded. Moreover, the TCS 14 processes transaction rules that may be unique for various circumstances or entities. For example, a user of the mobile device 12 may establish and configure transaction rules that weight all factor values evenly, whereas the TCS 14 may include service transaction rules that apply a standardized weighting policy that favors some factors over others. Moreover, the user may configure the transaction rules to scrutinize the mobile device interaction characteristics, user traits, and mobile device use characteristics based on specific criteria. As an example, the specific criteria could be a transaction's date and time, location, transaction amount as well as pertain to special occasions such as Christmas. Further still, a merchant using the POS terminal 16 may send rules to the TCS 14 that may be more or less strict than either the user transaction rules or the service transaction rules of the TCS 14. For example, the merchant rules may have different rule criteria such as not allowing purchases of more than a certain amount between specific hours for an MSTC score that is less than a predetermined value. The following equation is useable to calculate an MSTC score:

MSTC=Δf1+Δf2+ . . . Δfn

The deltas in the equation represent the difference between the factors of the same type (e.g., f1, f2 . . . fn). The deltas are factor values that may be weighted by transaction rules such as those described above.

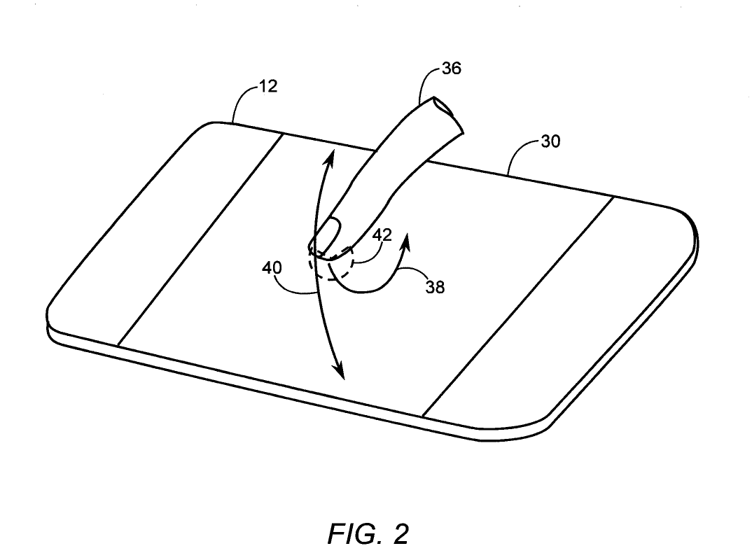

FIG. 2 depicts a user's interactions with the mobile device 12 by way of the touch screen interface 30. Operational data collected by the secure data collector 20 as the user interacts with the touch screen interface 30 can be recorded by the TCS to establish a mobile device interaction characteristic having a long term pattern and a short term pattern. As shown in FIG. 2, a user's finger 36 is used to input touch gestures 38 and/or swipe styles 40 via the touch screen interface 30. For example, swipe styles 40 making up the short term patterns and long term patterns may include, but are not limited to, right or left handedness along with swipe speed. Touch gestures 38 making up the recorded operational data may include, but are not limited to, fingertip contact size 42 as well as touch gesture speed or interval between touch gestures 38 while performing repetitive touch gesturing.

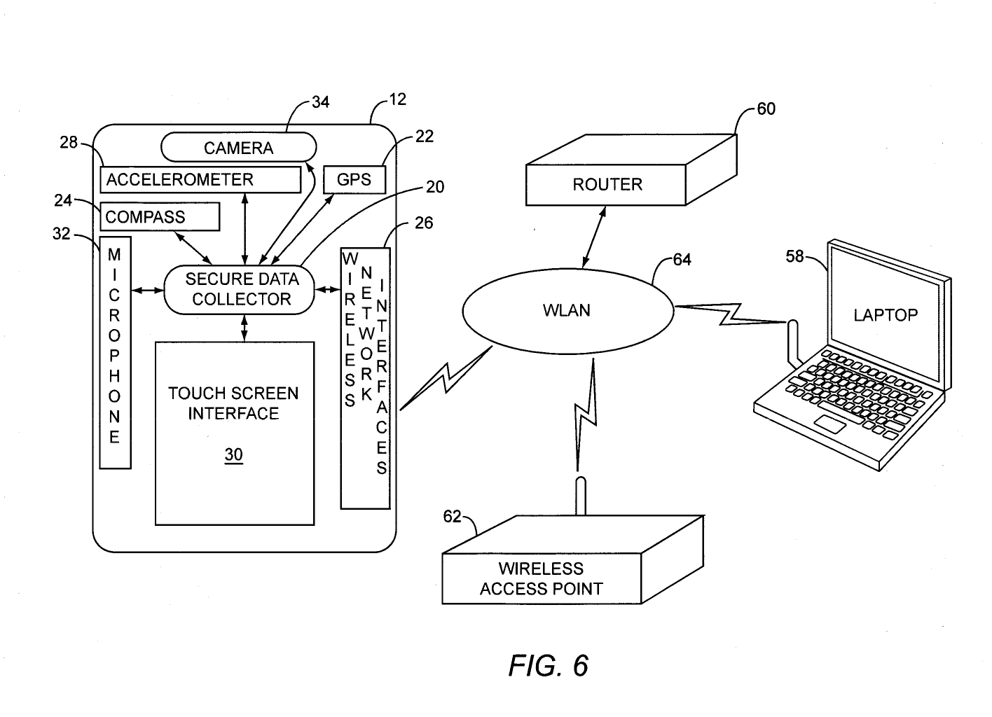

The secure data collector 20 (FIGS. 1 and 6) may also collect operational data of an acceleration factor type from the accelerometer 28. The secure data collector 20 will pass the operational data from the accelerometer on to the TCS 14 (FIG. 1) to record. The operational data for the acceleration factor type may include tilt values in degrees that indicate how the mobile device 12 is generally held during communication, such as during a phone conversation, while texting or processing email, etc. In this way, other mobile device interaction characteristics that are unique to the user of the mobile device 12 may be developed.

Moreover, the accelerometer 28 may also be employed to detect user traits. For example, the accelerometer 38 may be adapted as a pedometer to count the number of steps or strides per unit of time the user of the mobile device 12 generally takes while walking, running, or jogging. The step or stride count may be recorded as operational data of a pedometer factor type to establish a user trait pattern for the user of the mobile device 12.

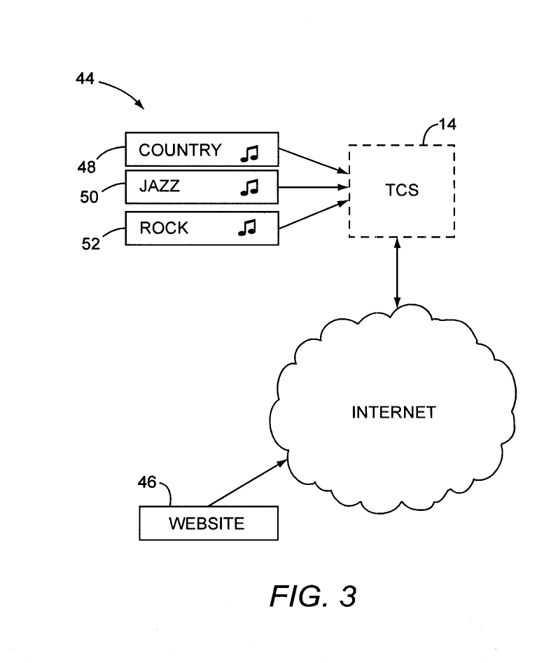

As depicted in FIG. 3, the TCS 14 may also establish short term patterns and long term patterns for digital content usage by recording operational data that pertains to how often particular songs or genres of music 44 are played, how often a website 46 is visited, etc. In this way, a mobile device use characteristic may be developed. For example, if the TCS 14 determines that a particular music genre, such as Country music 48, is consumed over a predetermined length of time, or at particular times or times of day, and then the TCS 14 determines the music genre is switched to a different music genre, such as Jazz music 50 or Rock music 52, for a predetermined length of time signifying that a different user may be in possession of the mobile device 12 (FIGS. 1, 2, 4, and 6), the TCS 14 will reduce the MSTC score.

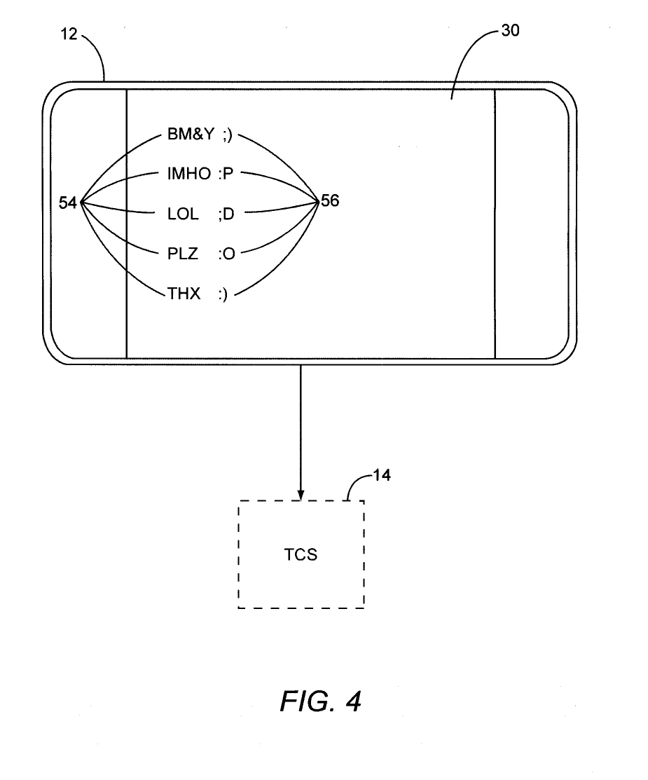

Another mobile device interaction characteristic may be developed by collecting data pertaining to texting activities. As depicted in FIG. 4, the TCS 14 may also record operational data pertaining to text message styles, such as abbreviations 66 that are generally used by the user of the mobile device 12. Texting activities may be a particularly good source for collecting operational data related to text message styles, such as the abbreviations 54. Another example of a text message style might be the frequent use of emoticons 56, such as a smiley face made with a colon or a semicolon symbol followed by a close parenthesis. A text message style that is frequently used, such as the emoticons 56, forms a pattern that is determinable from a comparison of short term and long term texting patterns. Moreover, texting frequency and texting times may also be collected and recorded as operational data to establish texting patterns for the mobile device 12. In either case, a texting type factor determined by the TCS 14 may be more heavily weighted similar to user trait type factors because such factors are not necessarily dependent upon the location or time of use of the mobile device 12.

At least a fraction of the operational data may be collected from an location based system (LBS) that gathers current and historical location data for the transport of the mobile device 12. For example, the GPS receiver 22 determines the location coordinates of the mobile device 12 at a predetermined interval, such as once every five minutes, etc. Upon detection of new location coordinates, the new location coordinates are time and date stamped and recorded to provide short term and long term patterns for the transport of the mobile device 12. In this way, a history of transport patterns for the mobile device 12 may be determined. For example, regular commutes and extended stays at particular locations, such as those involving the user's work location, develop a pattern that is regular for particular days and times of day.

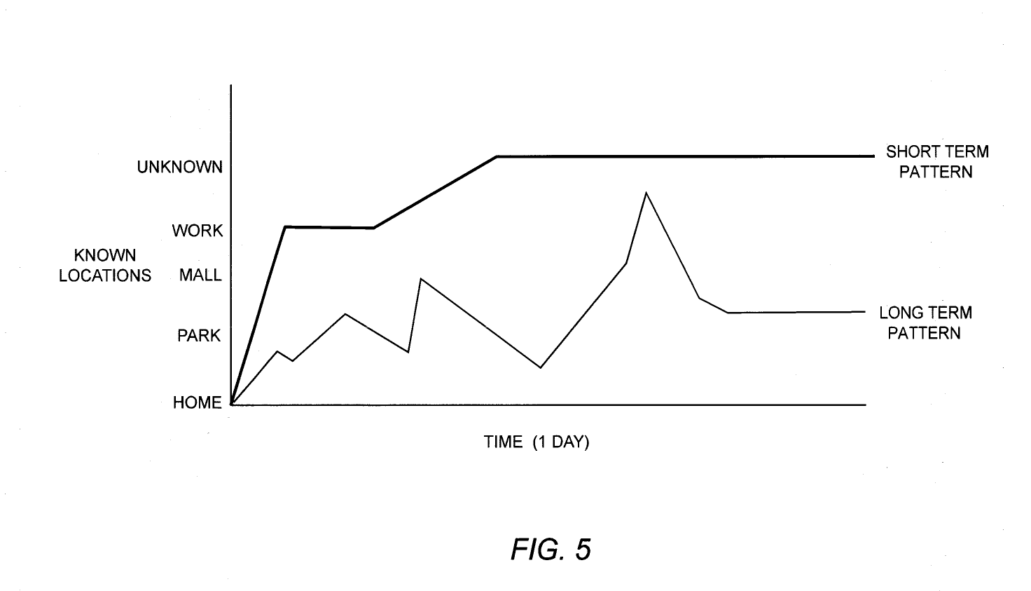

FIG. 5 is an exemplary graph showing a short term pattern and a long term pattern for known locations for the mobile device 12 versus a time of day. In this example, the TCS 14 will detect an anomaly between the short term pattern and the long term pattern for locations once the mobile device 12 is taken from the user's work location to an unknown location. As a result, a contribution from a location factor comparison between the short term and long term patterns will be negative and will reduce the MSTC score by an amount proportional to the difference between the short term pattern and long term pattern.

As shown in FIG. 6, the TCS 14 (FIG. 1) may also periodically query for networkable devices such as a laptop computer 58, a router 60, and a wireless access point 62, which may be in proximity and/or may be networked to the mobile device 12 via a wireless local area network (WLAN) 64 to gather media access (MAC) addresses and network addresses of the networkable devices. The MAC addresses and network addresses for the networkable devices, along with timestamps of when the addresses are received, make up additional operational data that is recorded by the TCS 14 to determine a transport pattern for the mobile device 12. For example, it may be that between 9 AM and 5 PM the user's laptop computer 58 is usually within wireless communication range of the user's mobile device 12. As a result, the TCS 14 may periodically query for, or observe network traffic to detect the MAC Ethernet address or other identifiers of the laptop computer 58 to establish a long term transport pattern. Other unique identifiers of the networkable devices, such as hardware and software versions, may also be recorded with timestamps to provide operational data that may be useable to establish regular transport patterns for the mobile device 12. Moreover, the system 10 (FIG. 1) may be adapted monitor, record and compare usage patterns associated with a music service, and a printer service, etc. that broadcasts availability over a network using a service discovery protocol such as Bonjour™ or Bluetooth. Examples of networkable devices may include, but are not limited to, a network printer, a network file system, a television and digital video recorder (DVR).

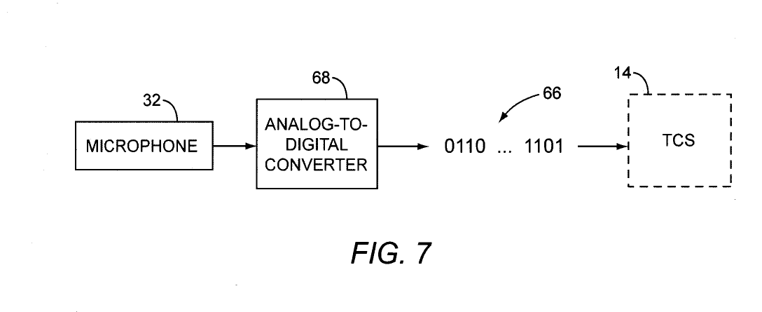

As depicted in FIG. 7, the secure data collector 20 (FIGS. 1 and 6) may also collect digitized voice samples 66 as operational data in order to establish short term and long term voice patterns for the user. For example, the TCS 14 may request that the user of the mobile device 12 (FIGS. 1, 2, 4, and 6) speak predetermined words in order to establish a voice pattern that is unique to the user of the mobile device 12. To complete the request, the user would speak the requested words into the microphone 32 (FIGS. 1, 6, and 7), which is interfaced to an analog-to-digital converter 68 that converts the user's analog speech into the digitized voice samples 66. The digitized voice samples 66 are collected by the secure data collector 20 and passed along to the TCS 14 to be recorded as a short term voice pattern.

The TCS 14 may then compare the short term voice pattern to a long term voice pattern in order to determine a factor of the voice pattern type. The voice pattern factor type may then be summed with other factors, such as the acceleration type factor, to calculate an MSTC score. The digitized voice samples 66 may rank high in generating an MSTC score in situations in which the TCS 14 detects that the mobile device 12 is not in a normal patterned environment for the user of the mobile device 12. For example, the mobile device 12 may be in the possession of the user while the user is at a location outside the mobile device's 12 normal environment. In such a situation, the TCS 14 may be configured by the user to more heavily weight the value of a voice pattern factor calculated from the digitized voice samples 66 and/or other biometric samples, such as an immediate photograph of the user taken with the camera 34 (FIGS. 1 and 6).

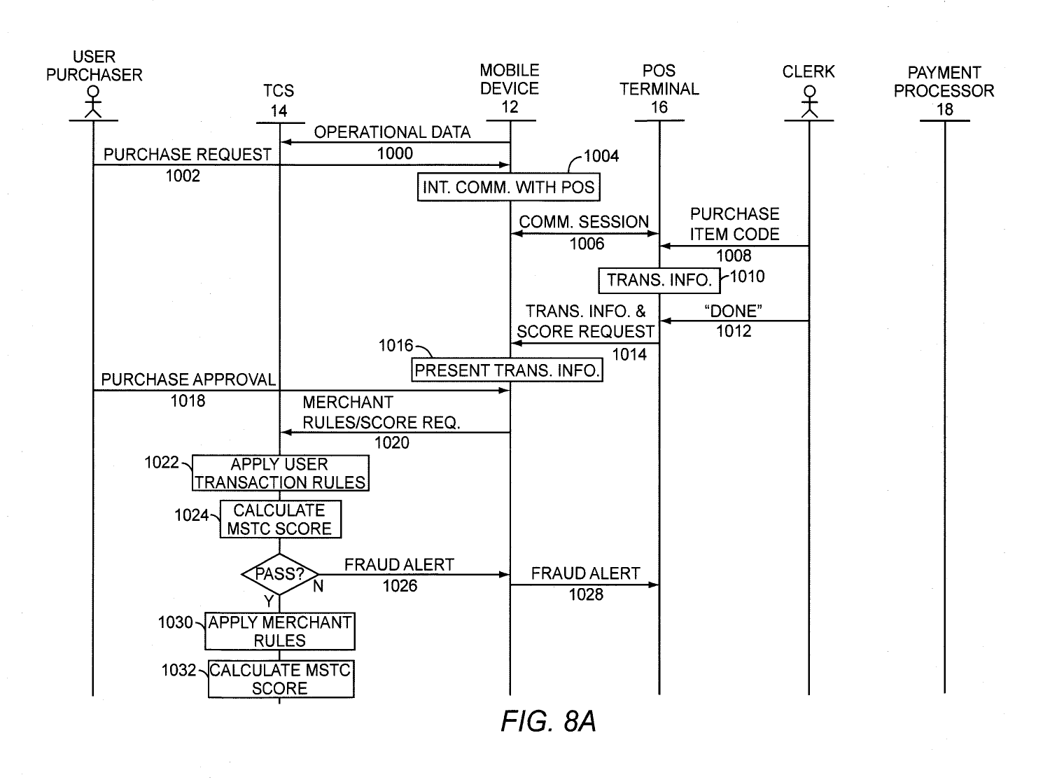

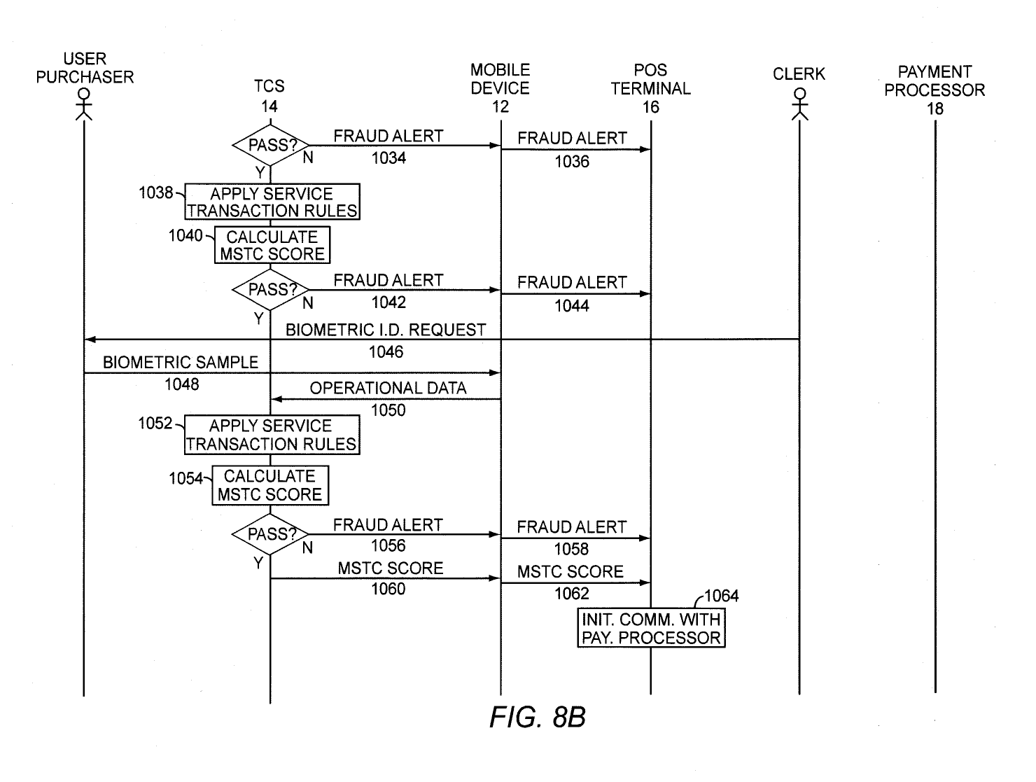

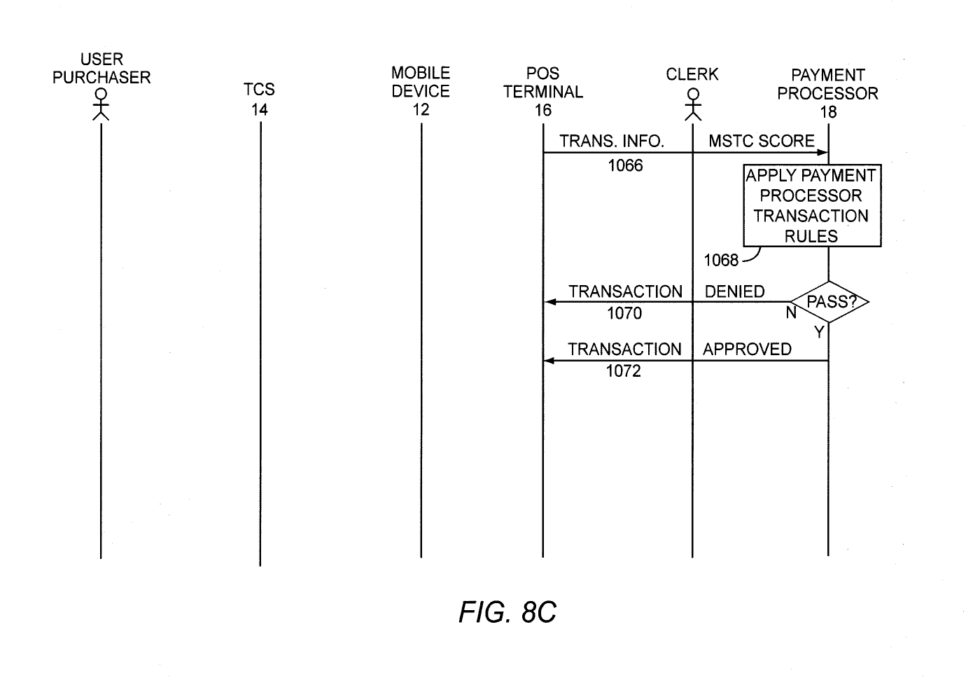

FIG. 8A depicts a typical flow for a purchase using the system 10 (FIG. 1) of the present disclosure. Operational data flows from the mobile device 12 to the TCS 14 to establish long term and short term patterns for each factor collected by the TCS 14 (step 1000). At some point in time, a user of the mobile device 12 makes a purchase request by placing his mobile device 12 into near field communication with the POS terminal 16 (step 1002). In response, the mobile device 12 prepares to communicate with the POS terminal 16 (step 1004). A communication session is established between the mobile device 12 and the POS terminal 16 (step 1006). The communication session may be initiated by either the mobile device 12 or the POS terminal 16. A clerk responds to the purchase request by entering a purchase item code into the POS terminal 16 (step 1008). The POS terminal 16 then returns transaction information, such as price and discounts for the purchase item, to the clerk (step 1010). If there are no other items to be purchased, the clerk enters a command into the POS terminal 16 to proceed with the purchase (step 1012). In response, the POS terminal 16 sends transaction information along with an MSTC score request and merchant rules to the mobile device 12 (step 1014).

The mobile device 12 then presents the transaction information to the purchaser (step 1016). The purchaser may then approve the purchase (step 1018). Once the purchase is approved, the merchant rules and the MSTC score request are sent to the TCS 14 (step 1020). While not essential, the purchaser may prefer that user transaction rules be processed first (step 1022). User transaction rules processing performed by the TCS 14 may weight various factor values more or less heavily based upon the purchaser's policy, which may be established by and included as data for access by the TCS 14.

The TCS 14 then calculates an MSTC score based on the results of the user transaction rules processing (step 1024). In this way, a fraud alert can be sent to the mobile device 12, which in turn immediately passes the fraud alert on to the POS terminal 16 to alert the clerk to possible fraud if the user transaction rules are not passed (steps 1026 and 1028).

However, if the user transaction rules are successfully passed, the merchant rules are processed (step 1030). Merchant rules processing performed by the TCS 14 may weight various factor values more or less heavily based upon the merchant's policy. The TCS 14 then calculates an MSTC score based on the merchant rules (step 1032).

Turning now to FIG. 8B, a fraud alert may be sent to the mobile device 12, which in turn may immediately pass the fraud alert on to the POS terminal 16 to alert the clerk to possible fraud if the merchant rules are not passed (steps 1034 and 1036). If the merchant rules are successfully passed, service transaction rules are processed (step 1038). The TCS 14 then calculates an MSTC score based on the service transaction rules (step 1040). If the service transaction rules are not successfully passed, a fraud alert can be sent to the mobile device 12, which in turn may immediately pass the fraud alert on to the POS terminal 16 to alert the clerk of possible fraud (steps 1042 and 1044).

At any time the clerk the may ask for additional identification, such as a biometric identification (step 1046). The purchaser may respond to the biometric identification request with a biometric response that may be, but is not limited to, holding the mobile device 12 at the purchaser's natural talk position, providing a voice sample by speaking into the microphone 32 (FIGS. 1, 6, and 7) of the mobile device 12, taking a self-photograph for automatic comparison with a stored self-photograph, making touch gestures on the touch screen interface 30 (FIGS. 1, 2, 4 and 6) of the mobile device 12, and taking a few steps while carrying the mobile device 12 so that the accelerometer 28 (FIGS. 1 and 6) of the mobile device 12 can provide pedometric data to the TCS 14 (step 1048).

Once the biometric response is acquired by the mobile device 12, the mobile device 12 sends the biometric response in the form of operational data to the TCS 14 (step 1050). The TCS 14 in turn reprocesses operational data with the service transaction rules (step 1052). An MSTC score is then calculated by the TCS 14 based on the outcome of the service transaction rules (step 1054). If the service transaction rules are not successfully passed, a fraud alert can be sent to the mobile device 12, which turn may immediately pass the fraud alert on to the POS terminal 16 to alert the clerk of possible fraud (steps 1056 and 1058).

However, if the service transaction rules are passed, the MSTC score is passed to the mobile device 12 (step 1060). The mobile device 12 in turn sends the MSTC score to the POS terminal 16 (step 1062). The POS terminal 16 may then initiate communication with the payment processor 18 (step 1064).

Turning now to FIG. 8C, the transaction information along with the MSTC score is sent to the payment processor 18 (step 1066). Once the MSTC score along with the transaction information is received, the payment processor 18 processes the MSTC score with the payment processor's 18 transaction rules (step 1068). If the payment processor's 18 transaction rules are not successfully passed, a transaction denied message is sent to the POS terminal 16 (step 1070). However, if the payment processor's 18 transaction rules are passed, then the payment processor 18 sends a transaction approved message to the POS terminal 16 and the transaction is completed (step 1072).

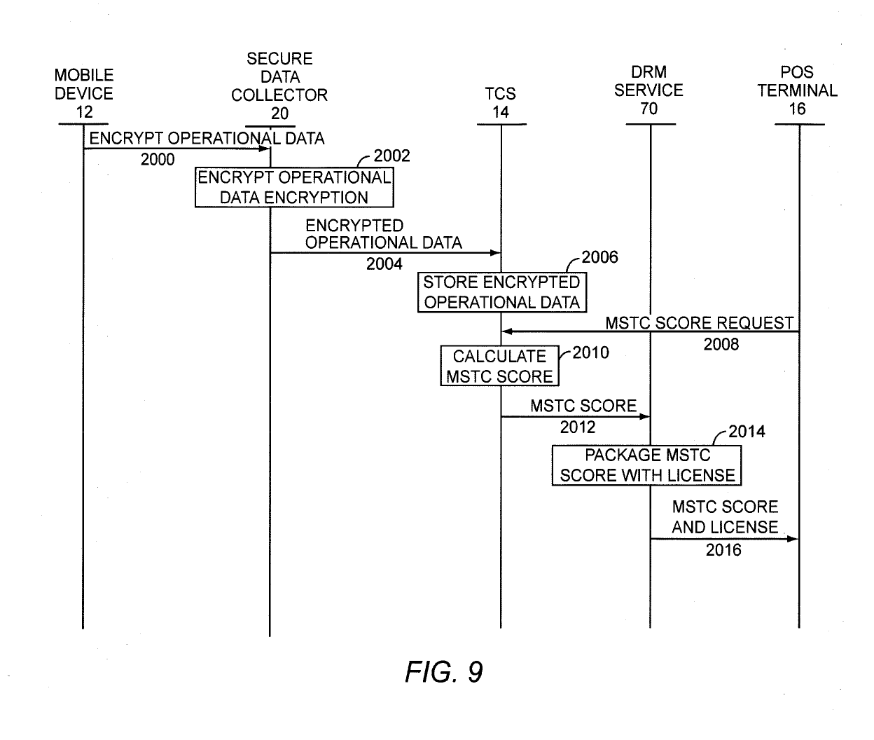

FIG. 9 depicts a secure data process flow in accordance with the present disclosure. The process begins when the secure data collector 20 gathers operational data from the mobile device 12 (step 2000). The operational data is then encrypted using well established encryption techniques (step 2002). The encrypted operational data is then transferred to the TCS 14 (step 2004). The TCS 14 then stores the encrypted operational data securely on the mobile device 12 (2006). The operational data may be stored on a remote server (not shown) when the TCS 14 is remotely located from the mobile device 12.

During a purchase transaction, the POS terminal 16 may request an MSTC score (step 2008). In response, the TCS 14 will calculate an MSTC score (step 2010). If a user of the mobile device 12 desires enhanced security regarding the use of the MSTC score, the MSTC score may be accessed using a rights management system such as a Digital Rights Management (DRM) service 70. In such a case, the MSTC score is transmitted to the DRM service 70 (step 2012). The DRM service 70 then packages the MSTC score with a license that allows merchants or payment processors to be granted rights to the MSTC score for a limited amount of time (step 2014). The MSTC score and license are then transmitted to the POS terminal 16 (step 2016). It should be understood that other confidence report data may also be included and transmitted securely along with the MSTC score.

In another operational example, a user named Joe uses his mobile device 12 (FIGS. 1, 2, 4 and 6) for commerce transactions at his local book store. Joe uses a short message service (SMS) text based payment system, which requires him to login and send payment information to a vendor having the POS terminal 16 (FIG. 1). Joe has his authentication information on his mobile device 12 set to “remember me” so that he does not need to re-authenticate every time he uses his mobile device 12 to perform a business transaction.

Over time, the TCS 14 (FIG. 1) has securely collected and recorded a significant amount of operational data from Joe's mobile device 12. The operational data has been evaluated to establish mobile device 12 usage patterns. During a typical commerce transaction, Joe's mobile device 12 transmits an MSTC score to the merchant having the POS terminal 16 or to the payment processor 18.

In this example, Joe's mobile device 12 is stolen by a thief. The thief uses Joe's mobile device 12 in ways that do not match the usage patterns established by the TCS 14. For example, the thief holds Joe's mobile device 12 at a different orientation than Joe does during telephone conversations. Moreover, digitized voice samples 66 (FIG. 7) collected from the microphone 32 (FIGS. 1, 6, and 7) of Joe's mobile device 12 during the thief's telephone conversations do not match Joe's digitized voice samples 66. Further still, the thief walks with a different stride than Joe. As such, a comparison between the thief's footstep counts versus time and Joe's pedometric long term pattern results in a detectable pattern difference.

The TCS 14 calculates a low MSTC score based on all of the detectable usage pattern differences between Joe and the thief. Therefore, when the thief attempts to make a purchase with Joe's mobile device 12, the TCS 14 generates and transmits a confidence report having a low MSTC score to the payment processor 18. In turn, the payment processor 18 instructs a merchant to check the identification of the thief. When the thief fails to positively identify himself as Joe, the thief is arrested and the mobile device 12 is returned to Joe before a fraud can be committed.

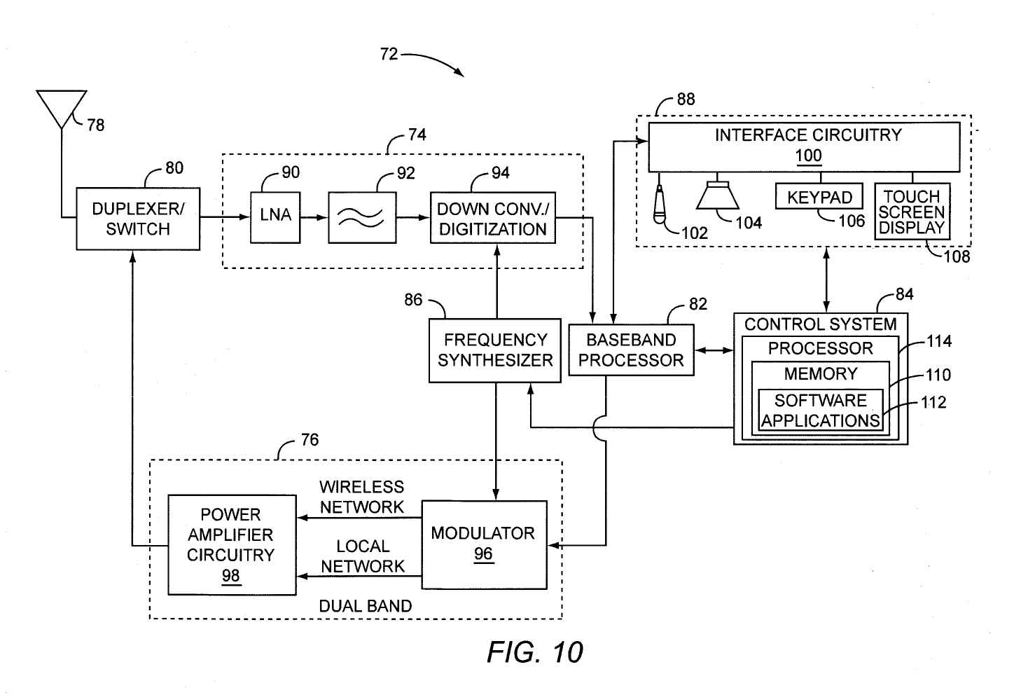

FIG. 10 depicts the basic architecture of a wireless smart phone 72 that is useable as the mobile device 12 (FIGS. 1, 2, 4, and 6). The wireless smart phone 72 may include a receiver front end 74, a radio frequency transmitter section 76, an antenna 78, a duplexer or switch 80, a baseband processor 82, a control system 84, a frequency synthesizer 86, and a user interface 88. The receiver front end 74 receives information bearing radio frequency signals from one or more remote transmitters provided by a base station (not shown). A low noise amplifier 90 amplifies the signal. A filter circuit 92 minimizes broadband interference in the received signal, while downconversion and digitization circuitry 94 downconverts the filtered, received signal to an intermediate or baseband frequency signal, which is then digitized into one or more digital streams. The receiver front end 74 typically uses one or more mixing frequencies generated by the frequency synthesizer 86. The baseband processor 82 processes the digitized received signal to extract the information or data bits conveyed in the received signal. This processing typically comprises demodulation, decoding, and error correction operations. As such, the baseband processor 82 is generally implemented in one or more digital signal processors (DSPs).

On the transmit side, the baseband processor 82 receives digitized data, which may represent voice, data, or control information, from the control system 84, which it encodes for transmission. The encoded data is output to the radio frequency transmitter section 76, where it is used by a modulator 96 to modulate a carrier signal that is at a desired transmit frequency. Power amplifier circuitry 98 amplifies the modulated carrier signal to a level appropriate for transmission, and delivers the amplified and modulated carrier signal to the antenna 78 through the duplexer or switch 80.

A user may interact with the wireless smart phone 72 via the user interface 88, which may include interface circuitry 100 associated with a microphone 102 that is usable as the microphone 32 (FIGS. 1, 6, and 7), a speaker 104, a physical or virtual keypad 106, and a touch screen display 108 that is usable as the touch screen interface 30 (FIGS. 1, 2, 4, and 6). The interface circuitry 100 typically includes analog-to-digital converters such as the analog-to-digital converter 68 (FIG. 7), digital-to-analog converters, amplifiers, and the like. Additionally, the interface circuitry 100 may include a voice encoder/decoder, in which case the interface circuitry 100 may communicate directly with the baseband processor 82.

The microphone 102 will typically convert audio input, such as the user's voice, into an electrical signal, which is then digitized and passed directly or indirectly to the baseband processor 82. Audio information encoded in the received signal is recovered by the baseband processor 82, and converted by the interface circuitry 100 into an analog signal suitable for driving the speaker 104. The keypad 106 and the touch screen display 108 enable the user to interact with the wireless smart phone 72, input numbers to be dialed, address book information, build texting strings or the like, as well as monitor call progress information.

The control system 84 includes a memory 110 for storing data and software applications 112, and a processor 114 for running the operating system and executing the software applications 112. Moreover, provided that the memory 110 is large enough and the processor 114 is powerful enough, an application that provides the function of the TCS 14 could be stored in the memory of the wireless smart phone 72 and executed by the processor of the wireless smart phone 72.

Those skilled in the art will recognize improvements and modifications to the preferred embodiments of the present invention. For example, the mobile device 12 may notify the POS 16 as to whether or not to use a TCS 14 that is internal or external to mobile device 12. In a case in which the TCS 14 is external to the mobile device 12, the POS 16 may communicate directly with the TCS 14 for increased efficiency and security. The use of an external TCS 14 prevents the possibility of a hacked mobile device 12 reporting a false MSTC score. Another improvement would allow a financial transaction to occur between two mobile devices such as mobile device 12. A possible scenario for mobile device to mobile device transactions would be one user wanting to transfer funds to another user by tapping the users' mobile devices together to facilitate a funds transfer. All such improvements and modifications are considered within the scope of the concepts disclosed herein and the claims that follow.

What is claimed is:

1. A computerized method for generating a mobile secure transaction confidence (MSTC) score and reporting the MSTC score to a financial transactor, the computerized method comprising:
collecting operational data from a mobile device, wherein the operational data is based on mobile device interaction characteristics, user traits, mobile device use characteristics, or any combination thereof;
recording the operational data to establish short term patterns and long term patterns for the mobile device interaction characteristics, the user traits, and the mobile device use characteristics;
comparing the short term patterns to the long term patterns to determine an MSTC score; and
effecting delivery of a report of the MSTC score to the financial transactor.

2. The computerized method of claim 1 wherein the operational data based upon mobile device interaction characteristics includes a touch screen interface swipe style.

3. The computerized method of claim 2 wherein the touch screen interface swipe style is a value representing either left-handedness or right-handedness.

4. The computerized method of claim 2 wherein the touch screen interface swipe style includes a swipe speed value.

5. The computerized method of claim 1 wherein the operational data based on mobile device interaction characteristics includes a touch gesture value.

6. The computerized method of claim 5 wherein the touch gesture value represents a stroke speed for a predetermined touch gesture.

7. The computerized method of claim 5 wherein the touch gesture value represents a fingertip contact size making a touch screen touch gesture.

8. The computerized method of claim 1 wherein the operational data based on mobile device interaction characteristics includes mobile device accelerometer readings.

9. The computerized method of claim 8 wherein the mobile device accelerometer readings represent tilt values associated with an orientation of the mobile device during at least one mobile device interaction.

10. The computerized method of claim 9 wherein the at least one mobile device interaction is a telephonic communication.

11. The computerized method of claim 9 wherein the at least one mobile device interaction is a texting communication.

12. The computerized method of claim 1 wherein the operational data based on user traits includes mobile device accelerometer readings.

13. The computerized method of claim 12 wherein the mobile device accelerometer readings are useable to derive footstep counts versus time to establish a short term and a long term pedometric pattern.

14. The computerized method of claim 1 wherein the operational data based on mobile device interaction characteristics includes a texting style.

15. The computerized method of claim 14 wherein the texting style includes abbreviations used by a mobile device user while texting.

16. The computerized method of claim 14 wherein the texting style includes emoticons used by a mobile device user while texting.

17. The computerized method of claim 1 wherein the operational data based on mobile device use characteristics include content consumption attributes.

18. The computerized method of claim 17 wherein the content consumption attributes include a frequency value indicating how often a particular website is visited.

19. The computerized method of claim 17 wherein the content consumption attributes includes a value that indicates when a particular music genre is changed to a different music genre.

20. The computerized method of claim 1 wherein comparing the short term patterns to the long term patterns to determine an MSTC score is supplemented with long and short term patterns that include digitized voice samples of a user.

21. The computerized method of claim 1 wherein comparing the short term patterns to the long term patterns to determine an MSTC score is supplemented with long term and short term patterns that include time stamped geographical positions indicating a transport of the mobile device.

22. The computerized method of claim 1 wherein comparing the short term patterns to the long term patterns to determine an MSTC score is supplemented with short term and long term patterns that include time stamped compass readings.

23. The computerized method of claim 1 wherein collecting the operational data for the mobile device includes encrypting the operational data.

24. The computerized method of claim 1 wherein a digital rights management function packages the MSTC score with a digital rights management license that grants the financial transactor a predetermined amount of access time to the MSTC score.

25. A system for generating a mobile secure transaction confidence (MSTC) score and reporting the MSTC to a financial transactor, the system comprising:
a mobile device having a memory for storing functions and data, a processor for executing the functions, a subsystem for generating operational data and at least one wireless network interface for communicating with networkable devices and financial transactors;
a secure data collector function stored in the memory for collecting the operational data from the subsystem, wherein the operational data is based on mobile device interaction characteristics, user traits, mobile device use characteristics, or any combination thereof;
a transaction confidence service (TCS) function stored in the memory of the mobile device for recording the operational data to establish short term and long term patterns for the mobile device interaction characteristics, the user traits, and the mobile device use characteristics and to compare the short term and long term patterns to determine an MSTC score; and
a communication function for effecting delivery of a report of the MSTC score to the financial transactor.
